(19) United States
(12) Patent Application Publication
(10) Pub. No.: US 2015/0021098 A1
(43) Pub. Date: Jan. 22, 2015

(54) BREAKER FLUIDS FOR WELLBORE FLUIDS AND METHODS OF USE

(71) Applicant: David P. Kippie, Katy, TX (US)

(72) Inventor: David P. Kippie, Katy, TX (US)

(73) Assignee: M-I L.L.C., Houston, TX (US)

(21) Appl. No.: 14/509,567

(22) Filed: Oct. 8, 2014

Related U.S. Application Data
(63) Continuation of application No. 14/128,273.

(51) Int. Cl. C09K 8/20; E21B 21/00

(52) U.S. Cl. CPC C09K 8/206; E21B 21/003; C09K 2208/30
USPC 175/72; 507/114; 507/111

(57) ABSTRACT

Compositions for controlling fluid loss may include an aqueous fluid, a viscosifier, a water soluble polar organic solvent, a delayed acid source, and a weighting agent. The composition may further comprise at least one selected from bridging solids, cleaning agent, dispersant, interfacial tension reducer, pH buffer, thinner, or surfactant. Such compositions may be used in producing a hydrocarbon from a formation by drilling the formation with a drill-in fluid to form a wellbore, emplacing the composition in the wellbore, and shutting the well for a predetermined time to allow the viscosity of the fluid loss composition to decrease.

### BACKGROUND

1. Field of the Disclosure

Embodiments relate generally to wellbore fluids. More specifically, embodiments relate to fluid loss pills and chemical breakers thereof.

2. Background Art

During the drilling of a wellbore, various fluids are typically used in the well for a variety of functions. The fluids may be circulated through a drill pipe and drill bit into the wellbore, and then may subsequently flow upward through the wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

One way of protecting the formation is by forming a filter cake on the surface of the subterranean formation. Filter cakes are formed when particles suspended in a wellbore fluid coat and plug the pores in the subterranean formation such that the filter cake prevents or reduces both the loss of fluids into the formation and the influx of fluids present in the formation. A number of ways of forming filter cakes are known in the art, including the use of bridging particles, cuttings created by the drilling process, polymeric additives, and precipitates. Fluid loss pills may also be used where a viscous pill comprising a polymer may be used to reduce the rate of loss of a wellbore fluid to the formation through its viscosity.

Upon completion of drilling, the filter cake and/or fluid loss pill may stabilize the wellbore during subsequent completion operations such as placement of a gravel pack in the wellbore. Additionally, during completion operations, when fluid loss is suspected, to reduce or prevent such fluid loss, a fluid loss pill of polymers may be spotted into the wellbore by injection of other completion fluids behind the fluid loss pill to a position within the wellbore that is immediately above a portion of the formation where fluid loss is suspected. Injection of fluids into the wellbore is then stopped, and fluid loss will then move the pill toward the fluid loss location.

After any completion operations have been accomplished, removal of filter cake (formed during drilling and/or completion) remaining on the sidewalls of the wellbore may be necessary. Although filter cake formation and use of fluid loss pills are essential to drilling and completion operations, the barriers can be a significant impediment to the production of hydrocarbon or other fluids from the well if, for example, the barriers created by the fluid loss pill are not well-timed or well-placed. Because filter cake is compact, it often adheres strongly to the formation and may not be readily or completely flushed out of the formation by fluid action alone.

The problems of efficient well clean-up, stimulation, and completion are a significant issue in all wells, and especially in open-hole horizontal well completions. The productivity of a well is somewhat dependent on the effective and efficient placement of fluid loss pills and timing of fluid loss pill effects, in order to minimize the potential of blocking, plugging, or otherwise damaging the natural flow channels of the formation, as well as those of the completion assembly.

Accordingly, there exists a need for fluid loss pills and breakers thereof having improved effectiveness to reduce damage to the formation while allowing for easy placement in the wellbore and control of the viscosity of the fluids in the fluid loss pill.

### SUMMARY

In one aspect, embodiments disclosed herein relate to a composition for use in controlling fluid loss, where the composition comprises an aqueous fluid, a viscosifier, a water soluble polar organic solvent, a delayed acid source, and a weighting agent. The composition may further comprise at least one selected from bridging solids, cleaning agent, dispersant, interfacial tension reducer, pH buffer, thinner, or surfactant.

In another aspect, embodiments disclosed herein relate to a method of producing a hydrocarbon from a formation, where the method comprises drilling the formation with a drill-in fluid to form a wellbore, emplacing a fluid loss composition in the wellbore, and shutting the well for a predetermined time to allow the viscosity of the fluid loss composition to decrease. The fluid loss composition may comprise an aqueous fluid, a viscosifier, a water soluble polar organic solvent, a delayed acid source, and a weighting agent.

Other aspects and advantages of embodiments will be apparent from the following description and the appended claims.

### DETAILED DESCRIPTION

In some aspects, embodiments disclosed herein are generally directed to fluid loss pills and breakers thereof that are useful in the drilling, completing, and working over of subterranean wells, preferably oil and gas wells. In particular aspects, the breaker for the fluid loss pills may be an internal breaker component, so that the pill itself may aid in its own destruction and removal following the desired fluid loss prevention/minimization.

In some embodiments, the fluid loss pills disclosed herein may include an aqueous fluid, a carboxylic acid ester or other delayed acid sources as the internal breaker component, a water soluble polar organic solvent, a viscosifier and optionally a weighting agent, such as a high density brine solution, and/or bridging solids. In particular embodiments, the carboxylic acid ester included in fluid loss pills disclosed herein may be a formate ester. In still further embodiments, the formate ester may be a formic acid or acetic ester of a C2 to C30 alcohol.

Particular embodiments disclosed herein involve methods of completing wellbores. The methods involve the use of fluid loss pill fluids and breakers thereof described herein, to minimize and/or prevent fluid loss to the formation during a completion operation, and then reduce the viscosity of the fluid loss pill over time. In some embodiments, the viscosity of the pill may control the timing of the breaker component release or activation, which then breaks or disrupts the pill for effective clean-up. More specifically, the carboxylic acid ester contained within the pill may act in a time-delayed manner to hydrolyze, releasing an organic acid, thereby reducing the viscosity of the fluid loss pill.

As mentioned above, the fluid loss pills may include a base fluid, a carboxylic acid ester or other delayed acid sources, water soluble polar organic solvent, a viscosifier, and optionally a weighting agent, such as a high density brine solution, and/or bridging solids. The aqueous fluid used in the water based fluids may be selected from the group including sea water, brines containing organic and/or inorganic dissolved salts, liquids containing water-miscible organic compounds, and combinations thereof.

As mentioned above, fluid loss pills used in various wellbore operations may be broken by an organic acid released from a delayed acid source, such as a hydrolysable ester, which may hydrolyze in situ. Illustrative examples of such delayed acid sources include hydrolyzable anhydrides of carboxylic acids, hydrolyzable esters of carboxylic acids; hydrolyzable esters of phosphonic acid, hydrolyzable esters of sulfonic acid and other similar hydrolyzable compounds that should be well known to those skilled in the art.

Suitable esters may include carboxylic acid esters so that the time to achieve hydrolysis is predetermined on the known downhole conditions, such as temperature and pH. In a particular embodiment, the delayed pH component may include a formic or acetic acid ester of a C2-C30 alcohol, which may be mono- or polyhydric. Other esters that may find use in activating the oxidative breaker of the present disclosure include those releasing C1-C6 carboxylic acids, including hydroxycarboxylic acids formed by the hydrolysis of lactones, such as γ-lactone and δ-lactone). In another embodiment, a hydrolyzable ester of a C1 to C6 carboxylic acid and/or a C2 to C30 poly alcohol, including alkyl orthoesters, may be used.

It is well known in the art that temperature, as well as the presence of a hydroxide ion source, has a substantial impact on the rate of hydrolysis of esters. For a given acid, for example formic acid, one of skill in the art can conduct simple studies to determine the time to hydrolysis at a given temperature. It is also known that as the length of the alcohol portion of the ester increases, the rate of hydrolysis decreases. Thus, by systematically varying the length and branching of the alcohol portion of the ester, the rate of release of the formic acid can be controlled and thus the timing of the breaking of a fluid loss pill may be predetermined. In particular embodiments, the carboxylic acid is a formic acid or acetic acid ester of a C2 to C30 alcohol, as mentioned above. In other embodiments, the delayed acid source includes amounts greater than about 1 volume percent of a fluid loss pill, or ranging from about 1 to 50 volume percent. However, one of ordinary skill in the art would appreciate that the preferred amount may vary, for example, on the rate of hydrolysis for the particular acid source used. One example of a suitable organic acid precursor is available from M-I L.L.C. (Houston, Tex.) under the name D-STRUCTOR™.

The water soluble polar organic solvent used in the fluid loss pill should have at least partial solubility in both an oleaginous fluid and an aqueous fluid. The polar organic solvent component may be a mono-hydric, di-hydric or poly-hydric alcohol or a mono-hydric, di-hydric, or poly-hydric alcohol having poly-functional groups. Examples of such compounds include aliphatic diols (i.e., glycols, 1,3-diols, 1,4-diols, etc.), aliphatic poly-ols (i.e., tri-ols, tetra-ols, etc.), polyglycols (i.e., polyethylenepropylene glycols, polypropylene glycol, polyethylene glycol, etc.), glycol ethers (i.e., diethylene glycol ether, triethylene glycol ether, polyethylene glycol ether, etc.) and other such similar compounds that may be found useful in the practice of embodiments of the present disclosure. In some embodiments, the water soluble organic solvent is a glycol or glycol ether, such as ethylene glycol mono-butyl ether (EGMBE). Other glycols or glycol ethers may be used in embodiments of the present disclosure so long as they are at least partially miscible with water.

In some illustrative embodiments, fluid loss pills may use a weighting agent such as a high density brine containing salts of alkali and alkaline earth metals. For example, brines formulated with high concentrations of sodium, potassium, or calcium salts of the halides, formate, acetate, nitrate, and the like; cesium salts of formate, acetate, nitrate, and the like, as well as other compounds that should be well known to one of skill in the art, may be used as solids free weighting agents. The selection of a weighting agent may partially depend upon the desired density of the fluid loss pill, as known by one of ordinary skill in the art.

Further, as described above, the breaker components of the present disclosure may be used in fluid loss pills viscosified by a variety of methods. Indeed, there exists no limitation on the type of viscosifiers or fluid loss pills in which the acid sources described herein may be used. For example, such viscosifiers may include viscoelastic surfactants (VESs), or natural polymers or polysaccharides such as starch derivatives, cellulose derivatives and biopolymers. Specifically, such natural polymers may include hydroxypropyl starch, hydroxyethyl starch, carboxymethyl starch, carboxymethyl cellulose, hydroxyethyl cellulose, hydroxypropyl cellulose, methyl cellulose, dihydroxypropyl cellulose, xanthan gum, gellan gum, welan gum, and schleroglucan gum, in addition to their derivatives thereof, and crosslinked derivatives thereof. Other embodiments may use synthetic polymers and oligomers such as poly(ethylene glycol) [PEG], poly(diallyl amine), poly(acrylamide), poly(aminomethylpropylsulfonate) [AMPS polymer], poly(acrylonitrile), poly(vinyl acetate), poly(vinyl alcohol), poly(vinyl amine), poly(vinyl sulfonate), poly(styryl sulfonate), poly(acrylate), poly(methyl acrylate), poly(methacrylate), poly(methyl methacrylate), poly(vinylpyrrolidone), poly(vinyl lactam) and co-, ter-, and quater-polymers of the following co-monomers: ethylene, butadiene, isoprene, styrene, divinylbenzene, divinyl amine, 1,4-pentadiene-3-one (divinyl ketone), 1,6-heptadiene-4-one (diallyl ketone), diallyl amine, ethylene glycol, acrylamide, AMPS, acrylonitrile, vinyl acetate, vinyl alcohol, vinyl amine, vinyl sulfonate, styryl sulfonate, acrylate, methyl acrylate, methacrylate, methyl methacrylate, vinylpyrrolidone, and vinyl lactam. Yet other viscosifiers include clay-based viscosifiers, especially laponite and other small fibrous clays such as the polygorskites (attapulgite and sepiolite). The amount of viscosifier used in the composition may vary depending on the type of fluid loss pill selected; however, normally about 0.1% to 6% by weight range is sufficient for most applications.

Some viscosifiers useful in fluid loss pills disclosed herein may include solids free viscosifiers, such as viscoelastic surfactant (VES) fluids; however, solids may be used in other embodiments. VES pills, such as those disclosed in U.S. Pat. No. 7,527,103, incorporated herein in its entirety by reference, are composed of low molecular weight surfactants that form elongated or “rod-like” micelle structures which exhibit viscoelastic behavior to increase fluid viscosity. VES pills are unlike polymer-based systems in that they are non-wall building and they do not form a true filter cake on the formation face. VES pills may or may not include breakers other than delayed acid source, such as mineral oils, hydrogenated polyalphaolefin oils, saturated fatty acids, and polyunsaturated fatty acids, among others.

Although some embodiments disclosed herein may contain polymeric viscosifiers, still other fluid loss pills of embodiments disclosed herein do not contain any polymeric viscosifiers, such as biopolymers, i.e., the fluids may be biopolymer free, such as those described in U.S. Pat. No. 6,300,286, incorporated herein in its entirety by reference. Further, in some embodiments the fluid loss pill fluids disclosed herein may use certain starch derivatives that function in certain dense brines to impart suspension characteristics and viscosity characteristics to the brines.

Further, some embodiments of fluid loss pills disclosed herein may include a hydratable polymer including natural or synthetic fibers. For example, linear polymers used to form fluid loss control pills may include hydroxyethylcellulose (HEC) or other cellulose derivatives, which may be optionally crosslinked by various means, such as polyvalent cations, as known in the art. Alternatively, other polysaccharides such as xanthan gum, guar gum, etc., may also be used.

Starch may also be used as a viscosifier in embodiments disclosed herein. Starch is a natural polymer containing an abundance of hydroxyl groups. In some embodiments, these hydroxyls may react with any chemical capable of reacting with alcoholic hydroxyls, including a wide range of compounds such as acid anhydrides, organic chloro compounds, aldehydes, epoxy, and ethylenic compounds, among others. When the specified chemical contains two or more moieties capable of reacting with hydroxyl groups, there is the possibility of reacting two different hydroxyls, resulting in crosslinking between hydroxyls on the same molecule or on different molecules.

Exemplary crosslinking materials may include, but are not limited to, epichlorohydrin and other epihalohydrins, formaldehyde, phosphorous oxychloride, trimetaphosphate, dialdehydes, vinyl sulfone, diepoxides, diisocyanates, and bis(hydroxymethyl)ethylene urea, among others.

Further, fluid loss pills may also contain other functional additives to impart specific properties to the fluids. Thus, the fluids may contain, bridging solids, weight materials (which may function as bridging agents in an appropriate particle size range), corrosion inhibitors, anti-oxidants, oxygen scavengers, reducing agents, supplemental fluid loss control additives, supplemental viscosifiers, thinners, thinning agents, cleaning agents, and the like.

In some embodiments, fluid loss pills disclosed herein may have bridging solids incorporated therein to bridge or block the pores of a subterranean formation. For example, useful bridging solids are well known in the art and may be solid, particulate, acid soluble materials, the particles of which have been sized to have a particle size distribution sufficient to seal off the pores of the formations contacted by the fluid loss pill fluids. Exemplary bridging solids may include calcium carbonate, limestone, marble, dolomite, iron carbonate, iron oxide, and the like. However, other solids may be used without departing from the scope of the present disclosure. In some embodiments of fluid loss pills disclosed herein, bridging solids may have a specific gravity less than about 3.0 and may be sufficiently acid soluble such that they readily decompose upon release of the organic acid, as discussed above.

Exemplary thinners that may be used in the fluid loss pill disclosed herein include, but are not limited to, lignosulfonates, modified lignosulfonates, polyphosphates, tannins, and low molecular weight polyacrylates. Thinners may be added to fluids to reduce flow resistance and control gelation tendencies. Other functions performed by thinners include reducing filtration and filter cake thickness, counteracting the effects of salts, minimizing the effects of water on the formations drilled, emulsifying oil in water, and stabilizing mud properties at elevated temperatures, among others.

In some embodiments, cleaning agents may be included in the fluid loss pill disclosed herein. A wide variety of synthetic and natural product derived cleaning agents may be used. For example, a common natural product derived cleaning agent is d-limonene.

Other embodiments disclosed herein involve methods of completing wellbores. The fluid loss pill may be injected into a work string, flow to bottom of the wellbore, and then out of the work string and into the annulus between the work string and the casing or wellbore. This batch of treatment is typically referred to as a “pill.” The pill may be pushed by injection of other completion fluids behind the pill to a position within the wellbore which is immediately above a portion of the formation where fluid loss is suspected. Injection of fluids into the wellbore is then stopped, and fluid loss will then move the pill toward the fluid loss location. Positioning the pill in a manner such as this is often referred to as “spotting” the pill. The fluid loss pill may form a plug near the wellbore surface, to significantly reduce fluid flow into the formation.

A breaker may be used to reduce the viscosity of the fluid loss pill and/or otherwise aid in disruption/degradation of the pill to clean up the well for subsequent production of the well. In some embodiments, the viscosity of the pill controls the timing of the breaker component release or activation, which, once released, may then break or disrupt the pill for effective clean-up. More specifically, the delayed acid contained within the pill hydrolyzes in a time-delayed manner to similarly reduce the viscosity of the fluid loss pill or otherwise degrade the pill in a time-delayed manner. Further while the breaker component described herein may be an internal breaker, residing in the fluid loss pill, in other embodiments, it may alternatively be used as an external breaker, emplaced downhole subsequent to the spotting of a fluid loss pill, upon desired degradation of the fluid loss pill.

Further, downhole conditions, including temperatures, differ according to the depth and location of the formation. The inventors of the present disclosure have discovered that it may be desirable to tailor the specific formulation of the fluid loss pill in accordance with the downhole temperatures expected in the region of the wellbore needing fluid loss prevention and subsequent cleaning of the fluid loss pill.

Thus, fluid loss pills disclosed herein may be used in the production of hydrocarbons from a formation. Following the drilling of a formation with a drilling mud, at least one completion operation may be performed on the well. In further embodiments, a fluid loss pill may be set in the wellbore during or after the performance of the at least one completion operation. In other embodiments, the fluid loss pill may be circulated either after a completion operation or after production of formation fluids has commenced to prevent or reduce fluid loss.

Generally, a well is often “completed” to allow for the flow of hydrocarbons out of the formation and up to the surface. As used herein, completion processes may include one or more of the strengthening of the well hole with casing, evaluating the pressure and temperature of the formation, and installing the proper completion equipment to ensure an efficient flow of hydrocarbons out of the well or in the case of an injector well, to allow for the injection of gas or water.

Completion operations, as used herein, may specifically include open hole completions, conventional perforated completions, sand exclusion completions, permanent completions, multiple zone completions, and drainhole completions, cleanout, gravel packing, or other completion operations, including tripping a tool string in or out of the well. A completed wellbore may contain at least one of a slotted liner, a predrilled liner, a wire wrapped screen, an expandable screen, a sand screen filter, a open hole gravel pack, or casing. In a particular embodiment, the fluid loss pill may be placed in the formation adjacent perforations, formation pores, etc, so that a filter may be formed and plug a perforation tunnel or pore throat, e.g., in a cased or open-hole completion, until cleanout. For example, fluid loss pills may be used to control leak-off of completion brine after perforating and before gravel packing or frac-packing. Because the pill may degrade spontaneously after a certain period of time at the downhole conditions, triggered by hydrolysis of the delayed acid source, the methods and fluids of the present disclosure may allow for the effective removal of the pill from the well to facilitate proper gravel placement in the perforation tunnels, for example.

In other embodiments, the fluids of the present disclosure may be emplaced in a well to seal the formation face in the completion zone prior to gravel placement. The fluid described herein may be positioned in the wellbore to contact the formation face at the perforations and may then be overbalanced to force the liquid phase into the formation and form a filtercake by bridging the perforations with the bridging material.

In another embodiment, the fluids of the present disclosure may be emplaced in a well on a screen after gravel packing. For example, a pill may be used to isolate the completion and wellbore fluid after gravel packing by spotting the pill inside the screen. In an embodiment where the completion operation comprises using a valve to isolate the formation from the wellbore fluid, the filter cake on the screen may inhibit fluid loss in the event of valve failure. In an alternate or additional embodiment, the completion operation may include pulling a wash pipe or service tool from adjacent the screen, assembling production tubing to the screen, a combination thereof or the like. In yet another embodiment, regardless of whether the filter cake is internal or external, the completion operation may include tripping a tool string in or out of the well.

As mentioned above, the fluids loss pills of the present disclosure are also suitable for use in open hole completions. Open hole completions refers to wellbores having underreamed zones wherein the producing formation is underreamed to enhance productivity. The fluid loss pills described herein may be positioned in the wellbore to contact the formation face and overbalanced to force the liquid carrier into the formation and form a filtercake by screening the bridging agent particles at the entrances to the pores or other passages opening at the formation surface.

The amount of delay between the time when a fluid loss is introduced to a well and the time when the delayed acid source hydrolyzes may depend on several variables. The rate of hydrolysis of the hydrolysable ester may be dependent upon the downhole temperature, concentration, pH, amount of available water, pill composition, etc.

However, depending on the downhole conditions, the fluid loss pill formulation and thus the pill's chemical properties may be varied so as to allow for a desirable and controllable amount of delay prior to the hydrolysis of the ester for a particular application. In some embodiments, the amount of delay for a fluid loss pill to be broken with delayed acid source according to embodiments of the present invention may be greater than 1 hour. In various other embodiments, the amount of delay according to embodiments of the present invention may be greater than 3 hours, 5 hours, or 10 hours. In other embodiments, the amount of delay for the fluids of a fluid loss pill to be broken with breakers according to embodiments of the present invention may be greater than 15 hours. In various other embodiments, the amount of delay for a fluid loss pill to be broken with breaker fluids may be greater than 24 hours, 48 hours, or 72 hours.

In some embodiments, the mechanism of breaking fluid loss pills includes a reduction in viscosity over time. In some embodiments, the mechanism of the time-delayed viscosity reduction is due to the hydrolysis of the carboxylic acid ester or other acid source. In one embodiment, viscosity may be reduced by greater than 50%. In other embodiments, viscosity may be reduced by greater than 80% or greater than 95%.

The following non-limiting examples are provided to further illustrate the application and the use of the methods and compositions of embodiments of the present invention.

### EXAMPLES

The following examples were used to test the effectiveness of a delayed acid breaker used in a fluid loss pill:

### Comparative Example 1

A water based fluid loss pill was formulated having the following components, all of which are commercially available. The fluid loss pill was created by mixing 1.25 SG NaBr and 7.3 ppb SAFE-VIS LE and adding 20 vol. % 1.25 SG NaBr. The fluid loss pill's rheological properties were measured using a Fann 35 viscometer (available from the Fann Instrument Company (Houston, Tex.) at 120° F. The measured properties are shown below in Table 1.

TABLE 1
Control Sample

| Days | 1 | 2 | 3 | 7 | 8 | 16 |
|---|---|---|---|---|---|---|
| 600 RPM | 107 | 111 | 112 | 118 | 127 | 133 |
| 300 RPM | 79 | 81 | 85 | 89 | 97 | 118 |
| 200 RPM | 66 | 68 | 71 | 75 | 81 | 95 |
| 100 RPM | 47 | 48 | 50 | 54 | 58 | 63 |
| 6 RPM | 7 | 7 | 8 | 8 | 9 | 11 |
| 3 RPM | 4.3 | 4 | 4.4 | 5 | 6 | 7 |
| Gels 10” (lbs/100 ft²) | 3.7 | 3.8 | 3.8 | 4.5 | 5 | 5.1 |
| Gels 10’ (lbs/100 ft²) | 4.3 | 4 | 4.3 | 4.5 | 9 | 4.7 |

### Example 1

A fluid loss pill was formulated having the following components, all of which are commercially available. The fluid loss pill was created by mixing 1.25 SG NaBr and 7.3 ppb SAFE-VIS LE and adding 20 vol. % 1.25 SG NaBr with 30 vol. % D-STRUCTOR. The composition was static aged at 60° C. for several days. The fluid loss pill's rheological properties were measured using a Fann 35 viscometer at 120° F. The measured properties are shown below in Table 2.

TABLE 2
D-STRUCTOR Sample

| Days | 1 | 2 | 3 | 7 | 8 | 16 |
|---|---|---|---|---|---|---|
| 600 RPM | 98 | 96 | 94 | 76 | 68 | 44 |
| 300 RPM | 72 | 70 | 66 | 49 | 48 | 21 |
| 200 RPM | 60 | 58 | 53 | 38 | 31 | 18 |
| 100 RPM | 42 | 40 | 36 | 23 | 17 | 8 |
| 6 RPM | 6.1 | 5 | 4 | 1.6 | 1.4 | 0.4 |
| 3 RPM | 3.6 | 4 | 2 | 0.8 | 1 | 0.4 |
| Gels 10” (lbs/100 ft²) | 3.1 | 1.6 | 1.6 | 0.6 | 0.4 | 0.1 |
| Gels 10’ (lbs/100 ft²) | 3.1 | 2.1 | 1.8 | 0.6 | 0.6 | 0.1 |

While reference has been made to particular applications for the fluid loss pills of embodiments of the present disclosure, it is expressly within the scope of embodiments of the present disclosure that these fluids may be in used in a variety of well applications. Specifically, the fluids of the present invention may be used in both producing and injection wells, and may have further application in remedial clean-up of wells.

Advantageously, embodiments of the present disclosure provide for a fluid loss pill that may reduce or prevent fluid loss without inflicting damage on the surrounding formation. Pills according to the present invention may exhibit high-viscosity indices such that they may behave as a high viscosity pill in the well completion process, but that may allow for subsequent degradation following activation of the internal breaker. The chemical properties of the fluid loss pills disclosed herein may allow for the reduction in the viscosity of the fluid loss pill over time.

While embodiments of the invention have been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A composition comprising:
an aqueous fluid;
a viscosifier;
a water soluble polar organic solvent;
a delayed acid source; and
a weighting agent.

2. The composition of claim 1, wherein the water soluble polar organic solvent is a glycol or glycol ether.

3. The composition of claim 1, wherein the delayed acid source is a formic acid or acetic acid ester of a C2 to C30 alcohol.

4. The composition of claim 1, wherein the weighting agent comprises at least one of halide or formate salts of alkali or alkaline earth metals.

5. The composition of claim 1, further comprising:
at least one selected from bridging solids, a cleaning agent, a dispersant, an interfacial tension reducer, a pH buffer, a thinner, or a surfactant.

6. The composition of claim 1, wherein the aqueous fluid is selected from fresh water, sea water, a brine containing organic and/or inorganic dissolved salts, liquids containing water-miscible organic compounds or combinations thereof.

7. The composition of claim 1, wherein the viscosifier comprises a hydratable natural polymer.

8. The composition of claim 7, wherein the hydratable natural polymer comprises hydroxyethyl cellulose.

9. The composition of claim 1, wherein the viscosifier comprises one or more viscoelastic surfactant.

10. The composition of claim 1, wherein the viscosifier comprises starch.

11. The composition of claim 1, wherein the delayed acid source comprises from about 5 to about 50 volume percent of the solution.

12. A method of producing a hydrocarbon from a formation, the method comprising:
drilling the formation with a drill-in fluid to form a wellbore;
emplacing a fluid loss composition in the wellbore, wherein the fluid loss composition comprises:
an aqueous fluid;
a viscosifier;
a water soluble polar organic solvent;
a delayed acid source; and
a weighting agent; and
shutting the well for a predetermined time to allow the viscosity of the fluid loss composition to decrease.

13. The method of claim 12, further comprising:
allowing the formation fluids to enter into the well; and
producing fluids from the well.

14. The method of claim 12, wherein the emplacing the fluid loss composition occurs after producing the fluids from the well.

15. The method of claim 12, wherein the emplacing the fluid loss composition occurs simultaneous as performing an at least one completion operation.

16. The method of claim 12, further comprising performing at least one completion operation after the emplacing.

17. The method of claim 12, wherein the emplacing the fluid loss composition occurs after performing an at least one completion operation.

18. The method of claim 12, wherein the wellbore contains at least one of a slotted liner, a predrilled liner, a wire wrapped screen, an expandable screen, a sand screen filter, a open hole gravel pack, and casing.

19. The method of claim 12, wherein the delayed acid source is a formic acid or acetic acid ester of a C2 to C30 alcohol.

20. The method of claim 12, wherein the weighting agent comprises at least one of halide or formate salts of alkali or alkaline earth metals.

21. The method of claim 12, wherein the fluid loss composition further comprises at least one selected from bridging solids, a cleaning agent, a dispersant, an interfacial tension reducer, a pH buffer, a thinner, or a surfactant.

22. The method of claim 12, wherein the aqueous fluid is selected from fresh water, sea water, a brine containing organic and/or inorganic dissolved salts, liquids containing water-miscible organic compounds or combinations thereof.

23. The method of claim 12, wherein the viscosifier comprises a hydratable natural polymer.

24. The composition of claim 23, wherein the hydratable natural polymer comprises hydroxyethyl cellulose

25. The method of claim 12, wherein the viscosifier comprises one or more viscoelastic surfactant.

26. The method of claim 12, wherein the viscosifier comprises starch.

27. The method of claim 12, wherein the delayed acid source comprises from about 5 to about 50 volume percent of the solution.
